(19) United States
(12) Patent Application Publication
(10) Pub. No.: US 2011/0151266 A1
(43) Pub. Date: Jun. 23, 2011

(54) ANTICORROSION PIGMENTS WITH POSITIVE ZETA POTENTIAL

(75) Inventors: Stephan Hüffer, Munchen (DE); Helmut Witteler, Wachenheim (DE); Fabio Nicolini, Mutterstadt (DE); Albert Budiman Sugiharto, Mannheim (DE)

(73) Assignee: BASF SE, Ludwigshafen (DE)

(21) Appl. No.: 12/958,795

(22) Filed: Dec. 2, 2010

Related U.S. Application Data
(60) Provisional application No. 61/266,184, filed on Dec. 3, 2009.

(30) Foreign Application Priority Data
Dec. 3, 2009 (EP) 09177891.0

(51) Int. Cl. C08K 3/36; B32B 15/08; B05D 3/10; C08K 3/22

(52) U.S. Cl. 428/450; 427/387; 524/493; 524/432

(57) ABSTRACT

The present invention relates to the use of oxidic nanoparticles having an average particle size of 2 to 2000 nm in combination with at least one polycationic polymer as corrosion protection for metallic surfaces and also to a method of protecting metallic surfaces from corrosion, comprising the steps of:
i) providing a formulation comprising oxidic nanoparticles (a) and at least one polycationic polymer (b) and an application medium,
ii) applying the formulation to the metallic surface that is to be protected, and
iii) optionally drying and/or heat-treating the surface.

The present invention relates to the use of oxidic nanoparticles having an average particle size of 2 to 2000 nm in combination with at least one polycationic polymer as corrosion protection for metallic surfaces. This patent application claims the benefit of pending U.S. provisional patent application Ser. No. 61/266,184 filed Dec. 3, 2009 incorporated in its entity herein by reference.

The protection of metallic surfaces from corrosion is a field which has already been a topic of very long and intense investigation, since the damage caused by corrosion is economically very significant and great resources are regularly deployed in order to prevent and to eliminate the damage.

Corrosion on metals can be attributed very largely to chemical and electrochemical corrosion reactions, Anticorrosion pigments intervene in the corrosion process in a variety of ways. They act physically by extending the diffusion pathway traveled by water, oxygen, and other corrosive substances from the surface of the coating to the metal surface. Electrochemically acting anticorrosion pigments passivate the metal surface.

Particularly effective anticorrosion pigments are based on compounds which nowadays are no longer used, or used only with great limitations, on account of their harmfulness to human health and their ecotoxicological objectionability; examples include anticorrosion pigments containing lead and containing chromate. The phosphating of metallic surfaces is less desirable in this respect as well, on environmental grounds, owing to the additions of nickel that are required for effective phosphating.

It is known that nanoparticles composed, for example, of silicon dioxide, titanium dioxide, iron oxides or manganese oxides display a corrosion-inhibiting effect. This effect on the part of the nanoparticles, however, is not long-lived; the corrosion process is delayed only for a certain time, and, after the onset of the corrosion process, the nanoparticles used for corrosion protection lose their effect relatively rapidly.

It is an object of the present invention to provide improved corrosion protection which is accomplished without compounds that are known to be problematic from an ecotoxicological standpoint, being based, for example, on lead, chromium or nickel.

This object is achieved in accordance with the invention through the use of oxidic nanoparticles having an average particle size of 2 to 2000 nm (a) in combination with at least one polycationic polymer (b) for protecting metallic surfaces from corrosion.

The metallic surfaces protected in accordance with the invention with a combination of oxidic nanoparticles and at least one polycationic polymer exhibit a higher resistance to corrosion than do metallic surfaces protected only with the oxidic nanoparticles. The positive effect of the polycationic polymers on the corrosion protection of metallic surfaces by oxidic nanoparticles derives from the increase in the zeta potentials of the nanoparticles that is brought about by the presence of the polycationic polymers. As a consequence of corrosion processes beginning, for many substrates the cationic reduction of oxygen results in an increase in pH to around 9 to 13. As a consequence of the negative charging, the inorganic nanoparticles are attached less strongly to the metallic substrate surfaces, which are usually likewise negatively charged. The polycationic polymers accumulate at the surface of the nanoparticles, and increase their zeta potential. As a result, the adsorption of the nanoparticles on the metallic substrate surface is stabilized even when the pH is increased as a consequence of the corrosion processes that take place. This effect is independent of whether the nanoparticles or the polycationic polymers are applied in a polar dispersion medium such as water or in an apolar dispersion medium such as petroleum. Even when they are used in a binder, a significantly enhanced corrosion protection of metallic surfaces is obtained.

The present invention is elucidated in detail below

Typically the oxidic nanoparticles (a) and said at least one polycationic polymer (b) are used together in a formulation comprising (a) and (b).

The oxidic nanoparticles have an average particle size of 2 to 2000 nm, preferably of 5 to 1000 nm, and more preferably of 5 to 200 nm. The average particle size is determined typically by means of AFM and TEM.

The oxidic nanoparticles (a) may be selected from the oxidic materials known to the skilled worker to be suitable for producing nanoparticles. These materials are, more particularly, inorganic oxides of metals and semimetals. With preference in accordance with the invention the oxidic nanoparticles (a) are selected from the oxides silicon dioxide, titanium dioxide, iron oxides, including Fe(II), Fe(III) and Fe(II)—Fe(III) mixed oxides, titanium dioxide, zirconium dioxide, tantalum oxide, manganese oxides in oxidation states III and IV, and also mixed oxides, and mixtures thereof, examples being titanates such as BaTiO₃. With particular preference in accordance with the invention, nanoparticles are selected from silicon dioxide, titanium dioxide, and zinc oxide.

These nanoparticles can be produced by various methods known to the skilled worker. Typically the nanoparticles are generated by grinding steps, reactions in the gas phase, in a flame, by crystallization, precipitation, sol-gel processes, in a plasma, or by sublimation. The size of the nanoparticles is measured advantageously by means of analysis by electron microscopy, as for example by means of AFM or TEM. Nanoparticles suitable for the invention are also available commercially—for example, nanoscale silicon dioxide under the trade name Aerosil® from Evonik.

The oxidic nanoparticles for use in accordance with the invention are generally compatible with water and polar solvents. For use in apolar media such as petroleum, for example, it may be advantageous to treat the oxidic nanoparticles with a compound that renders the surface hydrophobic. Substances suitable for the hydrophobic modification of the oxidic nanoparticles are known to the skilled worker. This operation may take place, for example, by treatment with hexamethylenedisilazane, octamethylcyclotetrasiloxane, stearic acid or polypropylene oxide, Silica nanoparticles with corresponding hydrophobic modification are also available commercially—from Evonik, for example. In one preferred embodiment of the invention, hydrophobically modified nanoparticles are used. This applies particularly when the oxidic nanoparticles are used in an apolar application medium or dispersion medium.

In another preferred embodiment of the present invention, the oxidic nanoparticles are used in unmodified form, particularly when the application medium or dispersion medium is polar, and especially in the case where water is used as application medium or dispersion medium.

In accordance with the invention the oxidic nanoparticles are used in combination with at least one polycationic polymer. Polycationic in the context of the invention means that the polymer has a minimum charge density of more than 1 meq/g, preferably from 5 to 25 meq/g, and more preferably from 10 to 20 meq/g, measured in each case at a pH of 4 to 5.

In accordance with the invention it is possible to use all polymers which either comprise free or alkyl-substituted amino groups or quaternary ammonium groups in the polymer chain or carry secondary or tertiary amino groups or quaternary ammonium groups attached to the polymer chain directly or via intermediate members. These amino groups or quaternary ammonium groups may also be members of 5- or 6-membered ring systems, such as of morpholine, piperidine, piperazine or imidazole rings, for example. In accordance with the invention the cationic polymer may be selected from polyamides, polyimines and polyamines, polydiallyldimethylammonium chloride, polyvinylamine, polyvinylpyridine, polyvinylimidazole, and polyvinylpyrrolidone, and also natural and semisynthetic polymers, including cationically modified starch.

The polycationic polymers for use in accordance with the invention preferably have a number-average molecular weight in the range from 500 to 2 000 000 g/mol, preferably 750 g/mol to 100 000 g/mol. As polycationic polymer (b) it is preferred to use polyethylenimine, the polyethylenimine preferably having a number-average molecular weight of 500 g/mol to 125 000 g/mol, and more preferably 750 g/mol to 100 000 g/mol.

The polycationic polymers may be present in linear or branched form or in the form of what are called dendrimers; preferably they are present in the form of dendrimers. Particular preference is given in accordance with the invention to using polyethylenimine in dendrimer form. Polyethylenimines of this kind are available, for example, under the trade name Lupasol® from BASF SE. A more precise description of such polyimines is found, for example, in Macromolecules vol. 2, H.-G. Elias, 2007 Vol. 2, pages 447 to 456.

One particularly preferred embodiment of the invention uses as said at least one polycationic polymer polyethylenimine having a number-average molecular weight of 500 g/mol to 125 000 g/mol, preferably of 750 g/mol to 100 000 g/mol, in dendrimer form.

In accordance with the invention at least one polycationic polymer (b) is used; hence there may be one polycationic polymer used or else mixtures of two, three or more polycationic polymers.

The combination of oxidic nanoparticles (a) and at least one polycationic polymer (b) is a very effective protection against corrosion, even at low concentrations. Said at least one polycationic polymer (b) is used preferably in a deficit amount, based on the amount of oxidic nanoparticles. With preference in accordance with the invention the weight ratio of said at least one polycationic polymer (b) to oxidic nanoparticles (a) is 1:1000 to 1:1, preferably 1:100 to 1:2.

Generally speaking, especially in the case of galvanized surfaces or aluminum, there is an increase in pH as a result of the corrosion processes, usually to pH levels of more than 9.5. As a result of this, the surface of the nanoparticles takes on a negative charge—that is, the zeta potential of the nanoparticles becomes negative and there is desorption of the nanoparticles from the likewise negatively polarized (charged) metal surface. Through the use of the oxidic nanoparticles in combination with at least one polycationic polymer, the zeta potential of the oxidic nanoparticles is raised, in the presence of the at least one polycationic polymer, in the pH range from 5 to 13, preferably in the pH range from 7 to 11, to at least −2, preferably to at least −1, and more preferably to at least 0, measured at 25° C.

The oxidic nanoparticles in combination with said at least one polycationic polymer are typically applied by means of an application medium to the surface that is to be protected. Preferably the oxidic nanoparticles (a) and said at least one polycationic polymer (b) are used in an application medium at a total concentration of at least 0.1% by weight, based on the total amount of application medium (a), and (b), more preferably at a total concentration of at least 0.5% by weight. Typically the oxidic nanoparticles (a) and said at least one polycationic polymer (b) are used in a total concentration of not more than 3% by weight, preferably of not more than 2.5% by weight, based on the total amount of application medium (a), and (b), since an improvement in the corrosion protection effect cannot be achieved when the total concentration of (a) and (b) is increased, and so higher concentrations are atypical on economic grounds.

In accordance with the invention it is possible, through the oxidic nanoparticles (a) in combination with said at least one polycationic polymer (b), to protect all metallic surfaces which may typically be damaged by corrosion. These include, for example, steel surfaces and galvanized surfaces, surfaces of Al and Mg and also of alloys, based on ZnMg, for example.

The present invention further provides a method of protecting metallic surfaces from corrosion, comprising the steps of:
i) providing a formulation comprising oxidic nanoparticles (a) and at least one polycationic polymer (b) as described above and an application medium,
ii) applying the formulation to the metallic surface that is to be protected, and
iii) optionally drying and/or heat-treating the surface.

In step (i) of the method of the invention a formulation is provided which comprises oxidic nanoparticles (a) and also at least one polycationic polymer (b), as described comprehensively above. The weight ratio of said at least one polycationic polymer (b) to oxidic nanoparticles (b) is preferably 1:1000 to 1:1, more preferably 100:1 to 1:2. Additionally, the formulation comprises an application medium. The application medium serves as a means of applying the oxidic nanoparticles (a) and said at least one polycationic polymer (b) to the surface that is to be protected. This application medium is preferably fluid. The application medium may comprise simple solvents such as water, petroleum, alcohols, and the like, although application media used may also be coating systems which already comprise binders and optionally further additives customary for this purpose.

The oxidic nanoparticles and said at least one polycationic polymer are dissolved or dispersed in the application medium. The choice of application medium for producing the formulation is made according to the mandates of the end application, and extends to solvent-based/oleophilic systems and to water-based systems. Consequently it is possible to use all known solvents such as water, alcohols, glycols, esters, ketones, amides, hydrocarbons such as synthetic oils and waxes, and also natural systems such as linseed oil, modified linseed oils (alkyd resins), and natural waxes. The polycationic polymers accumulate on the surface of the oxidic nanoparticles. When a binder system is used as application medium it is also possible first to prepare a mixture of the oxidic nanoparticles and said at least one polycationic polymer in a solvent, and then to introduce this mixture into the binder system.

In step ii), the formulation is applied to the metallic surface that is to be protected. The formulation may be applied by means of known methods such as dipping, spraying, knife coating, spreading, roiling, and so on.

This is followed, optionally, by step iii): drying and/or heat treatment of the surface.

The present invention further provides a corrosion protection composition comprising:
0.1% to 3% by weight of oxidic nanoparticles having an average particle size of 1 to 2000 nm (a) and at least one polycationic polymer (b), as described above the weight ratio of (b) to (a) being 1:1000 to 1:1,
0.1% to 30% by weight of at least one emulsifier,
5% to 90% by weight of liquid dispersion medium,
0 to 5% by weight of at least one inorganic salt selected from phosphates and fluorides of Li, Na, K, Mg, Ca, Ba, Zn, Mn, Fe, Ti and/or Zr,
based on the total amount of the corrosion protection composition.

If said at least one inorganic salt is present in the corrosion protection composition, its minimum concentration is 0.1% by weight, based on the total amount of the corrosion protection composition.

The oxidic nanoparticles (a) present in the corrosion protection composition, and the at least one polycationic polymer (b) present therein, have been described above. The corrosion protection composition of the invention preferably comprises silicon dioxide as oxidic nanoparticles and polyethylenimine as polycationic polymer. Particular preference is given to using polyethylenimine having a number-average molecular weight of 500 g/mol to 125 000 g/mol, more preferably of 750 g/mol to 100 000 g/mol. Very particular preference is given to using polyethylenimine which is in dendrimer form.

As liquid dispersion medium it is possible to employ the systems and compounds specified above as application media.

The present invention further provides metallic surfaces protected from corrosion by the inventive use of oxidic nanoparticles (a) in combination with at least one polycationic polymer (b), as described above.

The invention is explained comprehensively below with reference to examples.

### A) Preparation of Pigment Dispersions

### EXAMPLES 1 to 7

Oxidic nanoparticles used were hydrophobicized silicon dioxide particles having an average particle size of 8 to 10 nm (manufacturer indication, trade name Aerosil® R 106 from Evonik). The polycationic polymer used was polyethylenimine having a molecular weight Mn of 800, 2000, 25 000 g/mol and a cationic charge density of 16 to 17 meq/g (Lupasol®FG, G 35, and WF from BASF SE).

1000 g of liquid paraffin (Tudalen® 3036, H&R Vertrieb GmbH, having a density of 0.86 g/ml and a kinematic viscosity of 17 mm2/s (40° C., DIN 51562)) are introduced into a 2 l vessel, and 50 g of hydrophobicized silicon dioxide particles are added. This initial charge is heated with stirring to 60° C. until a clear solution or a dispersion is obtained.

For examples 2 to 7, 150 g portions of the solution/dispersion were admixed at 40° C. with different amounts of the cationic polymer.

### EXAMPLES 8 to 10

Oxidic nanoparticles used were zinc oxide particles (VP AdNano Z 805 from Evonik) having an average particle size of 12 nm and a BET surface area>20 m²/g. The polycationic polymer used was polyethylimine having a molecular weight Mn of 800 or 2000 g/mol. 25 g of zinc oxide particles were heated with 500 g of liquid paraffin (corresponding to example 1), with stirring, to 60° C., and a dispersion was obtained.

### EXAMPLES 11 to 16

Oxidic nanoparticles used were silicon dioxide particles (Aerosil® 200 from Evonik) having an average particle size of 12 nm and a BET surface area of 170+/−125 m²/g (manufacturer indications); the polycationic polymer used were the polyethylenimines described for examples 1 to 7. In each example, 10 g of nanoparticles were introduced into 100 ml of deionized water. The dispersions were admixed in each case with 0.5 g, 0.75 g, 1.0 g, or 2.0 g of polyethylenimine, as described for example 1.

### EXAMPLES 17 to 22

60 g portions of the mixtures from examples 11 to 16 were introduced with stirring and at RT, in portions, into 120 ml portions of a 50% poly(styrene-acrylate) dispersion (Acronal® S 760 from BASF SE), which were then stirred for 20 minutes.

The indications given of amounts used and molecular weights of the respective polyethylenimine are summarized for examples 1 to 16 in tables 1 to 3. The charge density of the polyethylenimine was determined in each case at a pH of 4 to 5 and for all of the PEIs used was 16 to 17 meq/g.

### B) Determination of Zeta Potentials

For examples 1 to 7 and 11 to 16 the zeta potentials were determined. The zeta potentials were determined using the Zetasizer nano from Malvern, the potential of the nonaqueous formulations being concluded by analogy with the aqueous formulations, by assuming identical surface coverages at equal concentrations. The measurement of potential took place in each case—that is, with the hydrophobicized nanoparticles as well—in an aqueous medium. The samples were first introduced into water. For this purpose, the pigments were combined in a 1:3 ratio with water, followed by the amounts of polyethylenimine set out in table 1 (mg PEI/g nanoparticles for examples 1 to 7 and 11 to 16). In the case of the samples from examples 1 to 7, the procedure required more intensive commixing over a period of 30 minutes. Even in the case of the surface-modified pigments, however, suitable dispersions were obtained.

For the individual measurements, then, 1 g portions of this batch were diluted in 40 ml of 10 mmol/l KCl, The pH of these samples was then determined, and the mobility measured.

The measurements were commenced at the pH possessed by the samples following dilution. pH adjustment was carried out using HCl or NaOH, respectively, to allow the measurements to be carried out at pH levels of 7, 9, and 11.

Tables 1 and 3 list the polyethylenimines used, their concentrations, and the zeta potentials measured for examples 1 to 7 (Tab. 1) and 11 to 16 (Tab. 3),

TABLE 1
Hydrophobicized SiO₂ nanoparticles in liquid paraffin

| | | | | mg PEI/g | Zeta potential [(μm/s]/(V/cm)] | | |
|---|---|---|---|---|---|---|---|
| | PEI, Mn | Conc. PEI | Nano- | nano- | pH | pH | pH |
| | [g/mol] | [g/l] | particles | particles | 7 | 9 | 11 |
| Example 1 | — | 0 | SiO₂, Aerosil | 0 | −0.8 | −2.1 | −3.8 |
| (comparative) | | | R 106 | | | | |
| Example 2 | 800 | 0.86 | SiO₂, Aerosil | 20 | +2.1 | +1.0 | −1.7 |
| | | | R 106 | | | | |
| Example 3 | 800 | 4.3 | SiO₂, Aerosil | 100 | +2.8 | +2.6 | −0.2 |
| | | | R 106 | | | | |
| Example 4 | 800 | 8.53 | SiO₂, Aerosil | 200 | +3.4 | +3.0 | +0.3 |
| | | | R 106 | | | | |
| Example 5 | 800 | 16.9 | SiO₂, Aerosil | 400 | +3.5 | +3.0 | +0.5 |
| | | | R 106 | | | | |
| Example 6 | 2000 | 8.53 | SiO₂, Aerosil | 200 | +3.1 | +2.9 | +0.2 |
| | | | R 106 | | | | |
| Example 7 | 25000 | 8.53 | SiO₂, Aerosil | 200 | +2.9 | +2.6 | +0.1 |
| | | | R 106 | | | | |

TABLE 2
Zinc dioxide particles in liquid paraffin

| | | Conc. | | mg PEI/g | |
|---|---|---|---|---|---|
| | PEI, Mn | PEI | Nano- | nano- | Zeta potential |
| | [g/mol] | [g/l] | particles | particles | [(μm/s](V/cm)] |
| Example 8 | 800 | 4.3 | ZnO | | — |
| | | | VP AdNano | | |
| | | | Z 805 | | |
| Example 9 | 2000 | 4.3 | ZnO | | — |
| | | | VP AdNano | | |
| | | | Z 805 | | |
| Example 10 | — | 0 | ZnO | | — |
| | | | VP AdNano | | |
| | | | Z 805 | | |

TABLE 3
Unmodified silicon dioxide particles in water

| | | | | mg PEI/g | Zeta potential [(μm/s]/(V/cm)] | | |
|---|---|---|---|---|---|---|---|
| | PEI, Mn | Conc. PEI | Nano- | nano- | pH | pH | pH |
| | [g/mol] | [g/l] | particles | particles | 7 | 9 | 11 |
| Example 11 | — | 0 | SiO₂, | 0 | −1.8 | −3.0 | −3.8 |
| | | | Aerosil 200 | | | | |
| Example 12 | 800 | 2.27 | SiO₂, | 50 | +2.3 | +1.0 | −1.1 |
| | | | Aerosil 200 | | | | |
| Example 13 | 800 | 3.41 | SiO₂, | 75 | +3.1 | +2.6 | +0.2 |
| | | | Aerosil 200 | | | | |
| Example 14 | 800 | 4.55 | SiO₂, | 100 | +3.6 | +3.0 | +0.3 |
| | | | Aerosil 200 | | | | |
| Example 15 | 800 | 9.1 | SiO₂, | 200 | +3.9 | +3.4 | +0.6 |
| | | | Aerosil 200 | | | | |
| Example 16 | 2000 | 4.55 | SiO₂, | 200 | +3.7 | +3.3 | +0.7 |
| | | | Aerosil 200 | | | | |

Both for the hydrophobicized silicon dioxide particles and for the unmodified silicon dioxide particles, the addition of different polyethylenimines at different concentrations leads to an increase in the zeta potential to at least −1.7 in a pH range from 7 to 11, in comparison to the zeta potential of the silicon dioxide particles in the absence of the polyethylenimine, of −0.8 to −3.8.

### C) Corrosion Tests

Using the formulations from examples 1 to 22, 4 panels in each case of Gardobond® OC (steel panels) and Gardobond® OMBZ (electrolytically galvanized steel panels) with a size of 10.5×19 cm, from Chemetall, were knife-coated on one side. The application rate (wet) was monitored by gravimetry, with a range of 0.9-1.4 g/m² being maintained. The panels with the aqueous formulations were dried at 60° C. The panels coated with paraffin dispersion were subjected to the same heat treatment as the panels coated with aqueous dispersion.

The corrosion protection was investigated by two different methods. Two panels each were tested by the climatic cycling test (DIN ISO 9227, 3 weeks) and with the salt spray test in accordance with DIN 50017. In the case of testing in the salt chamber, the time at which corrosion (red rust) occurred on the steel panels was recorded, and they were given a rust index rating RI in accordance with ISO 10289 after 6 hours. In the case of the electrolytically galvanized panels, the rust index RI was determined after 3 days in the salt chamber. The ISO 10289 rust index rating level is given in table 4.

Tables 5 to 8 report the average values for the two panels in each case.

TABLE 4
ISO 10289 rust index RI

| | Rating level | | Rating level |
|---|---|---|---|
| Defect area % | R_{β} or R_{A} | Defect area % | R_{β} or R_{A} |
| no defect | 10 | 2.5 < A ≦ 5.0 | 5 |
| 0 < A ≦ 0.25 | 9 | 5.0 < A ≦ 10 | 4 |
| 0.25 < A ≦ 0.5 | 8 | 10 < A ≦ 25 | 3 |
| 0.5 < A ≦ 1.0 | 7 | 25 < A ≦ 50 | 2 |
| 1.0 < A ≦ 2.5 | 6 | 50 < A ≦ 75 | 1 |
| 2.5 < A ≦ 5.0 | 5 | 75 < A | 0 |

TABLE 5
Results of corrosion tests for examples 1 to 7
(hydrophobicized silicon dioxide particles in liquid paraffin)

| | | RI after salt | | RI after | |
|---|---|---|---|---|---|
| | RI after | spray test, | RI after | climatic | RI after |
| | climatic | steel panel | salt spray | cycling | salt spray |
| | cycling | time to | test (6 h), | test, | test (72 h), |
| | test, | corrosion | steel | galvanized | galvanized |
| | steel panel | [h] | panel | steel panel | steel panel |
| Example 1 | 1.5 | 0.5 | 0 | 3.5 | 1 |
| (compar- | | | | | |
| ative) | | | | | |
| Example 2 | 3 | 1 | 1 | 4 | 3.5 |
| Example 3 | 3.5 | 1.5 | 1 | 5 | 4 |
| Example 4 | 4 | 1.5 | 2 | 6 | 4 |
| Example 5 | 4.5 | 2.5 | 2 | 5.5 | 5 |
| Example 6 | 4.5 | 2 | 2 | 6 | 4 |
| Example 7 | 3.5 | 2 | 2.5 | 5 | 4 |

TABLE 6
Results of corrosion tests for examples 8 to 10
(zinc oxide particles in liquid paraffin)

| | RI after | RI after salt | RI after | RI after | RI after |
|---|---|---|---|---|---|
| | climatic | spray test, | salt | climatic | salt spray |
| | cycling | steel panel | spray | cycling | test (72 h), |
| | test, | time to | test (6 h), | test, | galva- |
| | steel | corrosion | steel | galvanized | nized |
| | panel | [h] | panel | steel panel | steel panel |
| Example 8 | 3 | 2 | 3 | 4 | 3.5 |
| Example 9 | 3 | 2 | 2.5 | 3 | 3 |
| Example 10 | 1.5 | 0.5 | 1 | 2 | 1.5 |
| (compar- | | | | | |
| ative) | | | | | |

TABLE 7
Results of corrosion tests for examples 11 to 16
(unmodified silicon dioxide particles in water)

| | RI after | RI after salt | RI after | RI after | RI after |
|---|---|---|---|---|---|
| | climatic | spray test, | salt | climatic | salt spray |
| | cycling | steel panel | spray | cycling | test (72 h), |
| | test, | time to | test (6 h), | test, | galva- |
| | steel | corrosion | steel | galvanized | nized |
| | panel | [h] | panel | steel panel | steel panel |
| Example 11 | 1 | 1 | 1 | 2.5 | 1.5 |
| (compar- | | | | | |
| ative) | | | | | |
| Example 12 | 2.5 | 2.5 | 2 | 4 | 2.5 |
| Example 13 | 3 | 2 | 2 | 4 | 3.5 |
| Example 14 | 2.5 | 3 | 3 | 5 | 4 |
| Example 15 | 3 | 3 | 2 | 5 | 5 |
| Example 16 | 4 | 3 | 2.5 | 5.5 | 5 |

TABLE 8
Results of corrosion tests from examples 17 to 26
(unmodified silicon dioxide particles as aqueous dispersion in binder)

| | RI after | RI after salt | RI after | RI after | RI after |
|---|---|---|---|---|---|
| | climatic | spray test, | salt | climatic | salt spray |
| | cycling | steel panel | spray | cycling | test (72 h), |
| | test, | time to | test (6 h), | test, | galva- |
| | steel | corrosion | steel | galvanized | nized |
| | panel | [h] | panel | steel panel | steel panel |
| Example 17 | 4.5 | 3.5 | 3 | 6 | 4 |
| (from Ex. 12) | | | | | |
| Example 18 | 5 | 3 | 3.5 | 6 | 5 |
| (from Ex. 13) | | | | | |
| Example 19 | 6 | 4 | 3.5 | 7.5 | 5.5 |
| (from Ex. 14) | | | | | |
| Example 20 | 5.5 | 4 | 4 | 8 | 5 |
| (from Ex. 15) | | | | | |
| Example 21 | 6 | 4 | 5 | 9 | 4.5 |
| (from Ex. 16) | | | | | |
| Example 22 | 2.5 | 1.5 | 1.5 | 3.5 | 1.5 |
| (from Ex. 11, | | | | | |
| compar- | | | | | |
| ative) | | | | | |

The corrosion protection of the metal panels is unequivocally increased through the use of the oxidic nanoparticles in combination with a polycationic polymer. This is independent of the nature of the particles (silicon dioxide, modified and unmodified, and zinc oxide) and of the application medium. The invention can be also be employed in systems already known for the protection of surfaces, such as paints, and contributes to a further increase in the corrosion protection effect of such coatings.

1.-14. (canceled)

15. A method for protecting a metallic surface from corrosion comprising the step applying oxidic nanoparticles having an average particle size of 2 to 2000 nm (a) in combination with at least one polycationic polymer (b) to the metallic surface that is to be protected.

16. The method according to claim 15, wherein the zeta potential of the oxidic nanoparticles (a) in the presence of said at least one polycationic polymer (b) in the pH range from 4 to 13 is at least −2, measured in aqueous phase at 25° C.

17. The method according to claim 15, wherein the weight ratio of said at least one polycationic polymer (b) to oxidic nanoparticles (a) is 1:1000 to 1:1.

18. The method according to claim 15, wherein the oxidic nanoparticles (a) are selected from the group consisting of silicon dioxide, iron oxide, zinc oxide, titanium dioxide, zirconium dioxide, tantalum oxide, manganese oxide, and mixtures thereof.

19. The method according to claim 15, wherein the oxidic nanoparticles (a) are hydrophobically modified.

20. The method according to claim 15, wherein said at least one polycationic polymer (b) is a polyamine, a polyimine, a polyamide, a polydiallyldimethylammonium chloride, a polyvinylamine, a polyvinylpyridine, a polyvinylimidazole, a polyvinylpyrrolidone, a natural polymer or a semisynthetic polymers or mixtures thereof.

21. The method according to claim 15, wherein said at least one polycationic polymer (b) is polyethylenimine,

22. The method according to claim 15, wherein said at least one polycationic polymer (b) has a number-average molecular weight of 500 g/mol to 2 000 000 g/mol.

23. The method according to claim 15, wherein said at least one polycationic polymer (b) is a dendrimer,

24. The method according to claim 15, wherein the oxidic nanoparticles (a) and said at least one polycationic polymer (b) are used in an application medium in a total concentration of at least 0.1% by weight, based on the total amount of (a), (b), and application medium.

25. A metallic surface protected from corrosion with the method as claimed in claim 15.

26. A method of protecting a metallic surface from corrosion, comprising the steps of:
i) providing a formulation comprising oxidic nanoparticles (a) and at least one polycationic polymer (b) and an application medium,
ii) applying the formulation to the metallic surface that is to be protected, and
iii) optionally drying and/or heat-treating the surface.

27. A corrosion protection composition comprising:
0.1% to 3% by weight of oxidic nanoparticles having an average particle size of 2 to 2000 nm (a) and at least one polycationic polymer (b), the weight ratio of (b) to (a) being 1:1000 to 1:1,
0.1% to 30% by weight of at least one emulsifier,
5% to 90% by weight of liquid dispersion medium,
0 to 5% by weight of at least one inorganic salt selected from phosphates or fluorides of Li, Na, K, Mg, Ca, Ba, Zn, Mn, Fe, Ti and/or Zr,
based on the total amount of the corrosion protection composition.

28. The corrosion protection composition according to claim 27, wherein the oxidic nanoparticles (a) are silicon dioxide and said at least one polycationic polymer is polyethylenimine (b).
